(19) United States
(12) Patent Application Publication
(10) Pub. No.: US 2014/0247289 A1
(43) Pub. Date: Sep. 4, 2014

(54) DISPLAY DEVICE AND PROCESSING METHOD OF IMAGE SIGNAL

(71) Applicant: Samsung Display Co., Ltd., Yongin-City (KR)

(72) Inventors: Geun Jeong PARK, Daegu (KR); Nam-Gon CHOI, Asan-si (KR); Jung-Taek KIM, Seoul (KR); Yong Jun JANG, Yongin-si (KR); Jin-Woong JEONG, Yongin-si (KR); Cheol Woo PARK, Suwon-si (KR)

(73) Assignee: Samsung Display Co., Ltd., Yongin-City (KR)

(21) Appl. No.: 14/011,029

(22) Filed: Aug. 27, 2013

(30) Foreign Application Priority Data
Mar. 4, 2013 (KR) 10-2013-0022925

(51) Int. Cl. G09G 5/10; G09G 3/36

(52) U.S. Cl. CPC G09G 5/10; G09G 3/3611
USPC 345/690; 345/88

(57) ABSTRACT

An image processing method includes: receiving an input image signal (IIS); doubling the IIS into frames; determining a TGM mode to control an order in which gamma curves (GC) are to be applied to the doubled IIS, the GCs including first and second GCs; applying the GCs to the doubled IIS based on the TGM mode to generate a doubled, TGM-processed image signal (DTIS); correcting the DTIS to generate a corrected image signal (CIS); and dither-processing the CIS to generate an output image signal. The dither-processing of the CIS includes: performing dither-processing by sequentially applying dithering patterns (DP) of a first DP set to the CIS in association with first ones of the frames with respect to the first GC, and performing the dither-processing by sequentially applying DPs of a second DP set to the CIS in association with second ones of the frames with respect to the second GC.

### CROSS-REFERENCE TO RELATED APPLICATION

This application claims priority from and the benefit of Korean Patent Application No. 10-2013-0022925, filed on Mar. 4, 2013, which is incorporated by reference for all purposes as if set forth herein.

### BACKGROUND

1. Field

Exemplary embodiments relate to display technology, and more particularly, to display devices and processing methods of image signals to improve visibility and image quality.

2. Discussion

A display device, such as a liquid crystal display (LCD), an organic light emitting diode (OLED) display, etc., generally includes a display panel, a gray voltage generating unit, and a data driver. The display panel usually includes a plurality of signal lines and a plurality of pixels including switching elements. The gray voltage generating unit is typically configured to generate a gray reference voltage. The data driver is usually configured to generate a plurality of gray voltages using the gray reference voltage, as well as configured to apply a gray voltage corresponding to an input image signal among the generated gray voltages to a data line as a data signal.

Conventional liquid crystal displays typically include a liquid crystal layer disposed between two display panels. The display panels usually include a pixel electrode and an opposing electrode. The liquid crystal layer may be configured having dielectric anisotropy; however, other liquid crystal molecule characteristics may be utilized. The pixel electrodes are usually arranged in a matrix form and connected to the switching elements, such as thin film transistors (TFTs), to sequentially (or otherwise) receive data voltages for each row. The opposing electrode may be formed on the entire surface of a display panel to receive a common voltage Vcom. In this manner, a desired image may be presented by applying the data voltages to the pixel electrode and the common voltage to the opposing electrode to generate an electric field in the liquid crystal layer. To this end, an intensity of the electric field may be regulated to control the transmittance of light through the liquid crystal layer.

Typically, a liquid crystal display will receive image signals having a plurality of primary colors, such as red, green, and blue, from a graphics source, such as an external graphics source. A signal controller of the liquid crystal display may process the image signals and then provide the processed image signals to a data driver. In this manner, the data driver may select an analog voltage corresponding to the image signal to apply the selected analog voltage to the display panel of the liquid crystal display as a data signal. The processing of the image signal may include color correction processing, e.g., accurate color capture (ACC) processing, etc., to compensate for a difference between gamma curves of each primary color to prevent a color corresponding to each gray from being changed.

Generally, the number of bits in an image signal input to the signal controller is the same as the number of bits capable of being processed by the data driver. The number of bits in the image signal processed before being converted into an analog data signal, however, may be larger than the number of bits capable of being processed by the data driver. As such, dithering techniques may be used to reduce the number of bits processed by the data driver, while, at the same time, creating the illusion of color depth by presenting a diffusion of available colors (i.e., the colors in the “color space” of the display device) in a pixel to approximate the presentation of unavailable colors (i.e., colors not in the “color space” of the display device). The diffusion of color may be presented “spatially” or “temporally.” Spatial diffusion is typically achieved by presented various available colors at a plurality of differently disposed pixels to approximate an unavailable color over the region occupied by the plurality of differently disposed pixels. Temporal diffusion is generally achieved by rapidly alternating the color value of one or more pixels between various available colors to approximate an unavailable color in a region corresponding to the one or more pixels.

Dithering techniques typically generate image signals by selecting only upper bits corresponding to the number of bits that can be processed in the data driver among the bits corresponding to the input image signal, which are reconfigured for each frame unit based on a defined dithering pattern selected based on the lower bits. The dithering pattern is a correction value set corresponding to a pixel. Expression of a gray color may be increased by controlling luminance using the dithering method. To this end, a display device may store a plurality of different dithering patterns for each gray and for each frame. In this manner, the display device may utilize the stored dithering patterns to effectuate the dithering method.

It is also noted that liquid crystal displays may be prone to side visibility deterioration as compared to front visibility presentation. To combat this effect, liquid crystal displays may be configured with individual pixels being divided into sub-pixels (e.g., two or more sub-pixels). The sub-pixels may then be driven utilizing different data voltages to increase the viewing angle of the corresponding display device.

Therefore, there is a need for an approach that provides efficient, cost effective techniques to improve image processing, which may improve visibility and image quality in display devices.

The above information disclosed in this Background section is only for enhancement of understanding of the background of the invention, and, therefore, it may contain information that does not form the prior art that is already known in this country to a person of ordinary skill in the art.

### SUMMARY

Exemplary embodiments provide a display device configured to improve visibility and image quality.

Exemplary embodiments provide a processing method of an image signal to improve visibility and image quality of an associated display device.

Additional aspects will be set forth in the detailed description which follows and, in part, will be apparent from the disclosure, or may be learned by practice of the invention.

According to exemplary embodiments, a method to process an image signal, includes: receiving an input image signal; doubling the input image signal into frames; determining a temporal gamma mixing (TGM) mode to control an order in which different gamma curves are to be applied to the doubled input image signal, the different gamma curves comprising a first gamma curve and a second gamma curve; applying the different gamma curves to the doubled input image signal based on the TGM mode to generate a doubled, TGM-processed image signal; correcting the doubled, TGM-processed input image signal to generate a corrected image signal; and dither-processing the corrected image signal to generate an output image signal. Dither-processing of the corrected image signal, includes: performing dither-processing by sequentially applying dithering patterns of a first dithering pattern set to the corrected image signal in association with first ones of the frames with respect to the first gamma curve, and performing dither-processing by sequentially applying dithering patterns of a second dithering pattern set to the corrected image signal in association with second ones of the frames with respect to the second gamma curve. The first dithering pattern set being different from the second dithering pattern set.

According to exemplary embodiments, a display device, includes: a temporal gamma mixing (TGM) unit configured to: double an input image signal into frames, and apply different gamma curves to the doubled input image signal to generate a doubled, TGM-processed image signal, the different gamma curves including a first gamma curve and a second gamma curve; an image signal correction unit configured to correct the doubled, TGM-processed image signal to generate a corrected image signal; and a dithering unit configured to dither-process the corrected image signal to generate an output image signal. The dithering unit is configured to perform the dither-processing by: sequentially applying dithering patterns of a first dithering pattern set to the corrected image signal in association with first ones of the frames with respect to the first gamma curve, and sequentially applying dithering patterns of a second dithering pattern set to the corrected image signal in association with second ones of the frames with respect to the second gamma curve. The first dithering pattern set is different from the second dithering pattern set.

According to exemplary embodiments, an apparatus, includes: at least one processor; and at least one memory including code, the at least one memory and the code configured to, with the at least one processor, cause the apparatus at least to: receive an input image signal, double the input image signal into frames, determine a temporal gamma mixing (TGM) mode to control an order in which different gamma curves are to be applied to the doubled input image signal, the different gamma curves including a first gamma curve and a second gamma curve, apply the different gamma curves to the doubled input image signal based on the TGM mode to generate a doubled, TGM-processed image signal, correct the doubled, TGM-processed image signal to generate a corrected image signal, and dither-process the corrected image signal to generate an output image signal. Performance of the dither-process on the corrected image signal includes: performance of the dither-process by sequential application of dithering patterns of a first dithering pattern set to the corrected image signal in association with first ones of the frames with respect to the first gamma curve, and performance of the dither-process by sequential application of dithering patterns of a second dithering pattern set to the corrected image signal in association with second ones of the frames with respect to the second gamma curve. The first dithering pattern set is different from the second dithering pattern set.

According to exemplary embodiments, the visibility and image quality of a display device may be improved.

The foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a block diagram of a liquid crystal display, according to exemplary embodiments.

FIGS. 2 and 3 are graphs of illustrative gamma curves of the liquid crystal display of FIG. 1, according to exemplary embodiments.

FIGS. 4-10 are corresponding diagrams of luminance of a pixel in different presentation frames of the liquid crystal display of FIG. 1, according to exemplary embodiments.

FIG. 11 is a diagram of luminance of a plurality of pixels and a polarity of data voltages in different presentation frames of the liquid crystal display of FIG. 1, according to exemplary embodiments.

FIG. 12 is a block diagram of an image signal processing unit of the liquid crystal display of FIG. 1, according to exemplary embodiments.

FIG. 13 is a graph illustrating a method to correct an image signal in the liquid crystal display of FIG. 1, according to exemplary embodiments.

FIG. 14 is a diagram of a dithering pattern, according to exemplary embodiments.

FIG. 15 is a diagram of an image signal processing method for a pixel in the liquid crystal display of FIG. 1, according to exemplary embodiments.

FIG. 16 is a timing diagram of an image signal processing method for a pixel in the liquid crystal display of FIG. 1 when a temporal gamma mixing (TGM) mode is an HL-LH or LH-HL mode, according to exemplary embodiments.

FIG. 17 is a timing diagram of an image signal processing method for a pixel in the liquid crystal display of FIG. 1 when a TGM mode is an HL-HL or LH-LH mode, according to exemplary embodiments.

FIG. 18 is a block diagram of a dithering unit, according to exemplary embodiments.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers and/or sections, these elements, components, regions, layers and/or sections should not be limited by these terms. These terms are used to distinguish one element, component, region, layer or section from another region, layer or section. Thus, a first element, component, region, layer or section discussed below could be termed a second element, component, region, layer or section without departing from the teachings of the present disclosure.

Spatially relative terms, such as “beneath,” “below,” “lower,” “above,” “upper,” and/or the like, may be used herein for descriptive purposes, and thereby, to describe one element or feature's relationship to another element(s) or feature(s) as illustrated in the drawings. Spatially relative terms are intended to encompass different orientations of an apparatus in use or operation in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and as such, the spatially relative descriptors used herein interpreted accordingly.

The terminology used herein is for the purpose of describing particular embodiments and is not intended to be limiting. As used herein, the singular forms “a,” “an,” and “the” are intended to include the plural forms as well, unless the context clearly indicates otherwise. Moreover, the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

While exemplary embodiments are described in association with liquid crystal display devices, it is contemplated that exemplary embodiments may be utilized in association with other or equivalent display devices, such as various self-emissive and/or non-self-emissive display technologies. For instance, self-emissive display devices may include organic light emitting displays (OLED), plasma display panels (PDP), etc., whereas non-self-emissive display devices may include electrophoretic displays (EPD), electrowetting displays (EWD), etc.

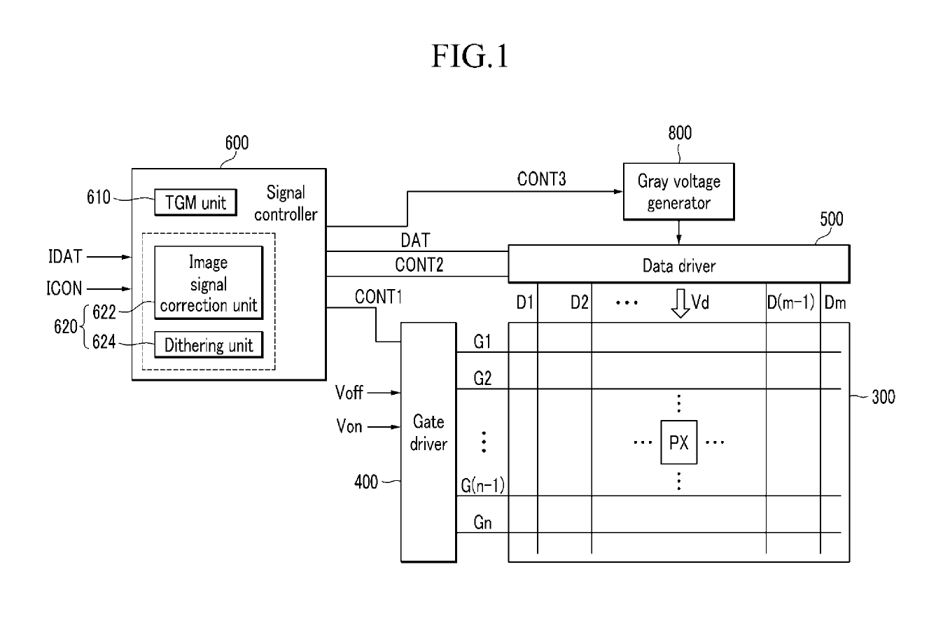

First, an exemplary liquid crystal display will be described in association with FIGS. 1-14.

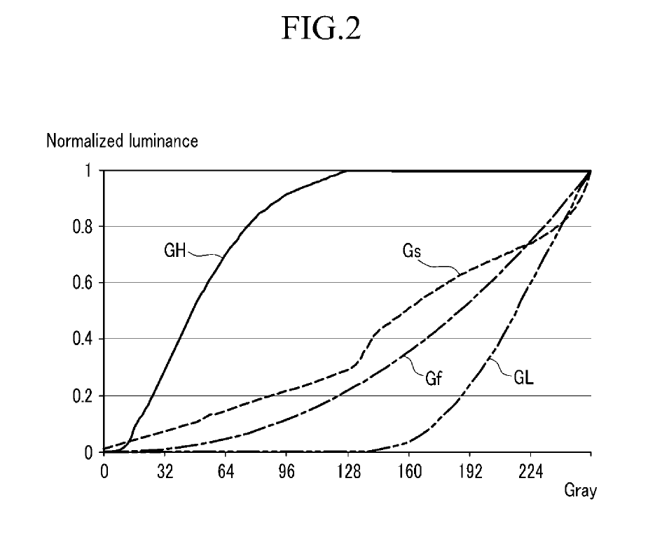

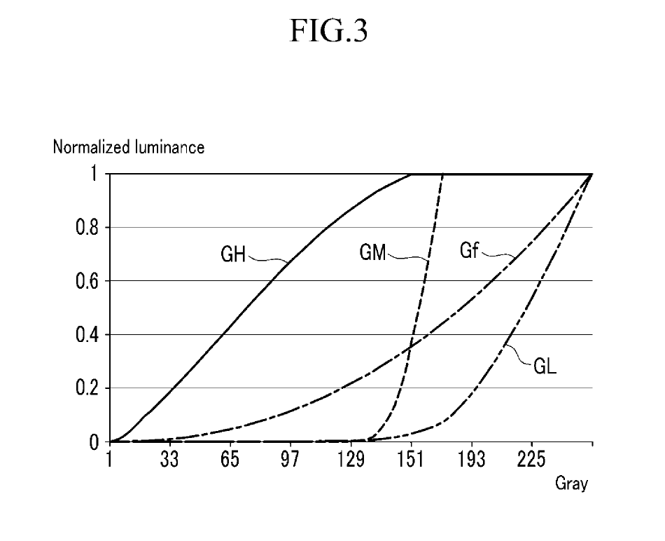

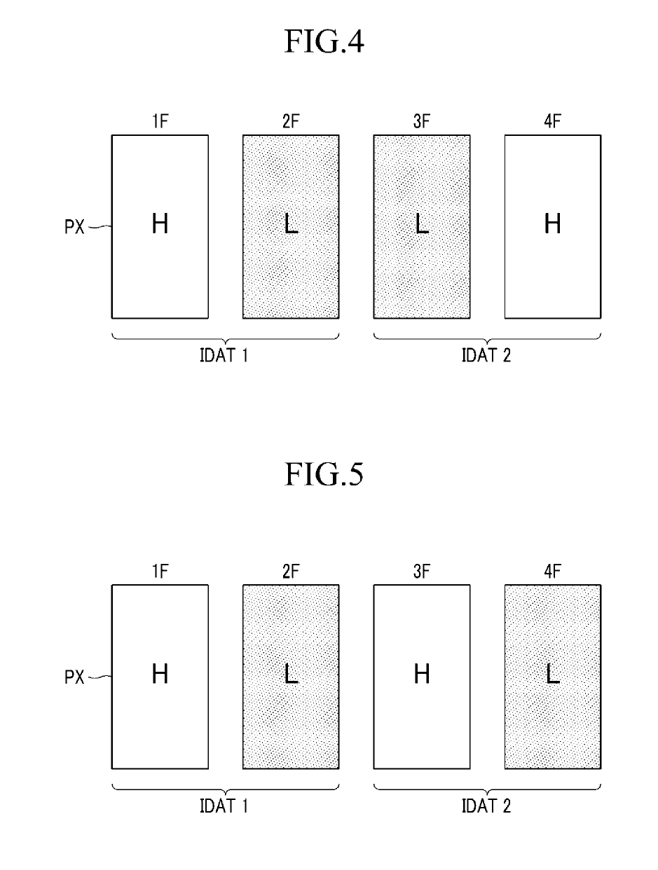

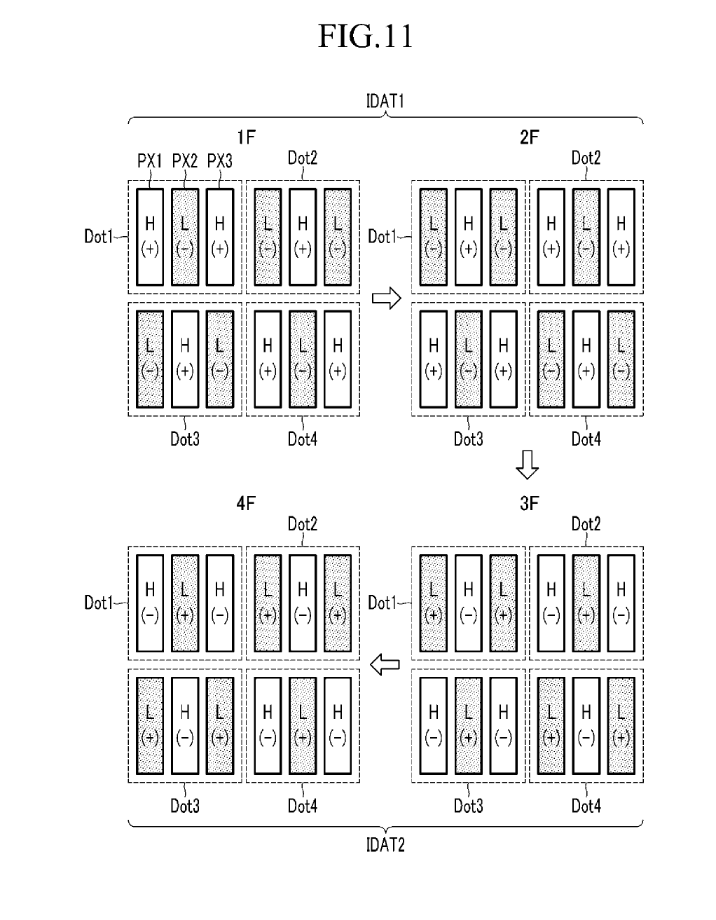

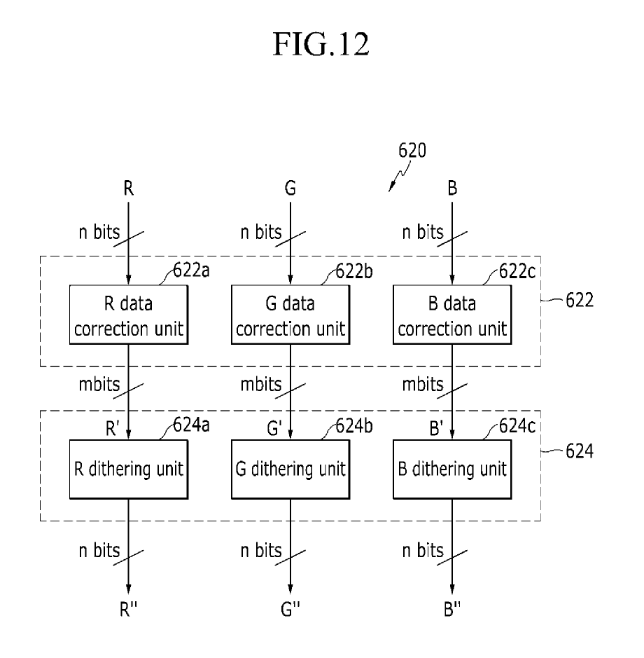

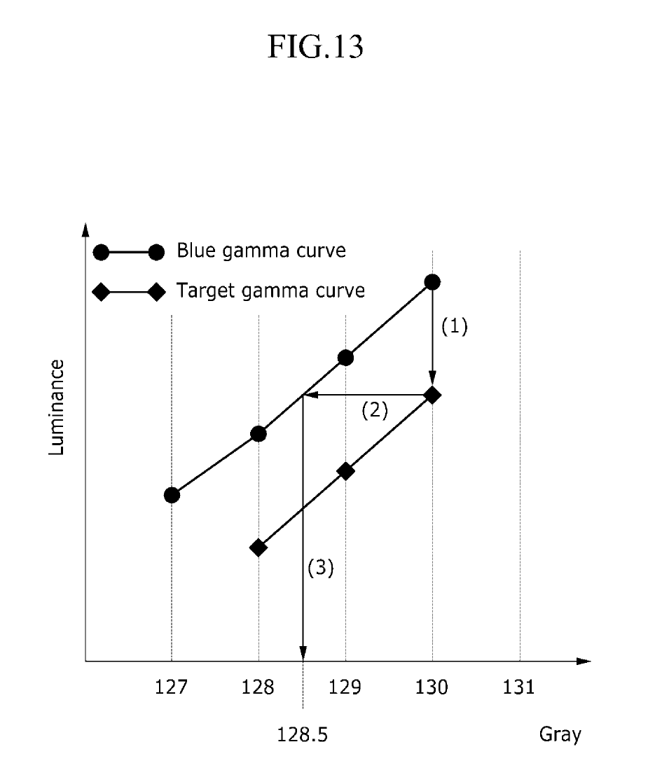

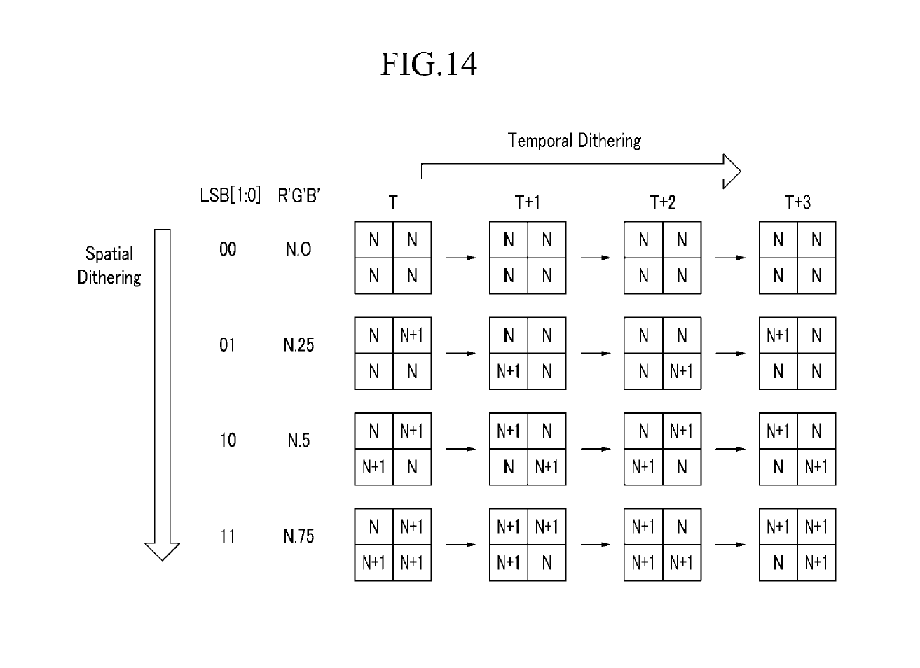

FIG. 1 is a block diagram of a liquid crystal display, according to exemplary embodiments. FIGS. 2 and 3 are graphs of illustrative gamma curves of the liquid crystal display of FIG. 1. FIGS. 4-10 are corresponding diagrams of luminance of a pixel in different presentation frames of the liquid crystal display of FIG. 1. FIG. 11 is a diagram of luminance of a plurality of pixels and a polarity of data voltages in different presentation frames of the liquid crystal display of FIG. 1. FIG. 12 is a block diagram of an image signal processing unit of the liquid crystal display of FIG. 1. FIG. 13 is a graph illustrating a method to correct an image signal in the liquid crystal display of FIG. 1. FIG. 14 is a diagram illustrating a dithering pattern, according to exemplary embodiments.

Referring to FIG. 1, a liquid crystal display includes a display panel 300, a gate driver 400 and a data driver 500 connected to the display panel 300, a gray voltage generator 800 connected to the data driver 500, and a signal controller 600 configured to control the display panel 300, the gate driver 400, the data driver 500, and the gray voltage generator 800. While specific reference will be made to this particular implementation, it is also contemplated that the liquid crystal display may embody many forms and include multiple and/or alternative components. For example, it is contemplated that the components of the liquid crystal display may be combined, located in separate structures, and/or separate locations.

According to exemplary embodiments, the display panel 300 includes a plurality of signal lines and a plurality of pixels PX connected to the signal lines. The pixels PX may be arranged in a substantially matrix form; however, any other suitable arrangement may be utilized. While not illustrated, the display panel 300 may include lower and upper panels facing each other with a liquid crystal layer disposed between the lower and upper panels.

The signal lines include a plurality of gate lines G1-Gn transferring gate signals (which may also be referred to as “scanning signals”) and a plurality of data lines D1-Dm transferring data voltages (which may also be referred to as one or more “data signals”).

Individual pixels PX include at least one switching element (not shown) connected to at least one data line Dj of the data lines D1-Dm and at least one gate line Gi of the gate lines G1-Gm. The switching element Q may include at least one thin film transistor, and may be controlled according to a gate signal transferred by the gate line Gi. Reception of the gate signal may be configured to cause the switching element Q to transfer a data voltage Vd received via the data line Dj to the corresponding pixel PX associated with the switching element Q.

According to exemplary embodiments, each pixel PX may be configured to display one or more of primary colors (e.g., spatial division) or configured to display the one or more primary colors with time (e.g., temporal division). In this manner, a desired color may be presented via the spatial and/or temporal sum of the presentation of the primary colors. It is contemplated, however, that the pixels PX may be configured to natively present any suitable color, such as, for example, a primary color, e.g., red, yellow, blue, and/or a non-primary color, e.g., green, magenta, white, etc.

The gray voltage generator 800 is configured to generate all gray voltages or a determined number of gray voltages (which may also be referred to as “reference gray voltages”) related to the transmittance of the pixels PX. The (reference) gray voltages may include a gray voltage having a positive value and/or a gray voltage having a negative value with respect to a common voltage Vcom. The gray voltage generator 800 may receive separately stored gamma data to generate the (reference) gray voltage based on the gamma data. According to exemplary embodiments, the gray voltage generator 800 may be included as part of the data driver 500 or any other suitable component of the liquid crystal display and/or a device interfacing with the liquid crystal display.

As seen in FIG. 1, the data driver 500 is connected to the data lines D1-Dm. The data driver 500 is configured to select a gray voltage from the gray voltage generator 800 based on an output image signal DAT received from the signal controller 600. In this manner, the data driver 500 is configured to apply the selected gray voltage to the data lines D1-Dm as a data voltage Vd. However, when the gray voltage generator 800 is not configured to provide all the gray voltages, but only a determined number of reference gray voltages, the data driver 500 may generate gray voltages for the entire gray scale by dividing the reference gray voltages and selecting the data voltage Vd from the available gray voltages.

The gate driver 400 is connected to the gate lines G1-Gn and is configured to apply a gate signal to the gate lines G1-Gn. The gate signal may be configured based on a combination of a gate-on voltage Von and a gate-off voltage Voff.

According to exemplary embodiments, the signal controller 600 is configured to receive an input image signal IDAT and an input control signal ICON from a graphic controller (not illustrated) and control operation of the gate driver 400, the data driver 500, the gray voltage generator 800, and the like. The graphic controller is configured to receive image data from an internal and/or external source and process the image data to generate the input image signal IDAT, which is transferred to the signal controller 600. For example, to reduce motion blur, the graphic controller may or may not perform a frame rate control in which an intermediate frame is inserted between adjacent frames, and the like.

Referring to FIG. 1, the signal controller 600 includes a temporal gamma mixing (TGM) unit 610 and an image signal processor 620.

The TGM unit 610 is configured to double the input image signal IDAT into a plurality of frames to which at least two kinds of different gamma curves are applied and process a TGM signal according to a TGM mode. The gamma curve is a curve governing luminance or transmittance for a gray scale of the input image signal IDAT, and the input image signal IDAT may be processed as a TGM signal based on the gamma curve and/or the (reference) gray voltage may be determined therefrom. TGM signal processing may include processing the input image signals IDAT to facilitate the display of images according to the same or different gamma curves in the plurality of doubled frames. When the reference gray voltage according to different gamma curves is generated by the gray voltage generator 800, the TGM signal processing may be omitted.

According to exemplary embodiments, a pixel PX may display images according to different gamma curves for a plurality of frames with respect to an input image signal IDAT, which may be referred to as time division driving. In association with time division driving, a kind and an order of the gamma curve applied for each frame may be referred to as a TGM mode and may be determined and stored in a memory associated with the liquid crystal display.

Various exemplary TGM modes will be described in more detail in association with FIGS. 2-11.

For example, referring to FIG. 2, the liquid crystal display may be configured to display images according to a first gamma curve GH and a second gamma curve GL which are different gamma curves with respect to an input image signal IDAT. Luminance of the image according to the first gamma curve GH may be greater than or equal to the luminance of the image according to the second gamma curve GL. The first and second gamma curves GH and GL may be adjusted so that a combined gamma curve Gs at the front of the first and second gamma curves GH and GL coincides with a front gamma curve Gf (for example, a gamma curve in which a gamma value is 2.2), which may be determined to be the most suitable for the display device and a combined gamma curve Gs at the side is the closest to the front gamma curve Gf, which may be utilized to improve side visibility of the display device.

As another example, referring to FIG. 3, the liquid crystal display may be configured to display images according to at least three different gamma curves with respect to an input image signal IDAT. The at least three gamma curves may include a first gamma curve GH, a second gamma curve GL, and a third gamma curve GM. Luminance of the image according to the first gamma curve GH may be greater than or equal to the luminance of the image according to the third gamma curve GM, and the luminance of the image according to the third gamma curve GM may be greater than or equal to the luminance of the image according to the second gamma curve GL. The first, second, and third gamma curves GH, GL, and GM may be adjusted so that a combined gamma curve (not shown) of displayed images for a frame set coincides with a front gamma curve Gf, which may be determined to be the most suitable for the display device and a combined gamma curve at the side is the closest to the front gamma curve Gf, which may be utilized to improve side visibility of a display device. In this manner, the first, second, and third gamma curves GH, GL, and GM may be selected so that an inflection point of the combined gamma curve is non-existent (or at least reduced) and is close to the front gamma curve Gf, which may increase display quality.

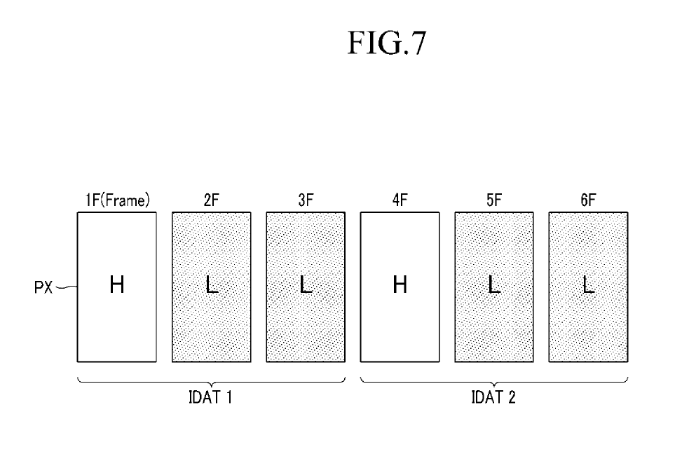

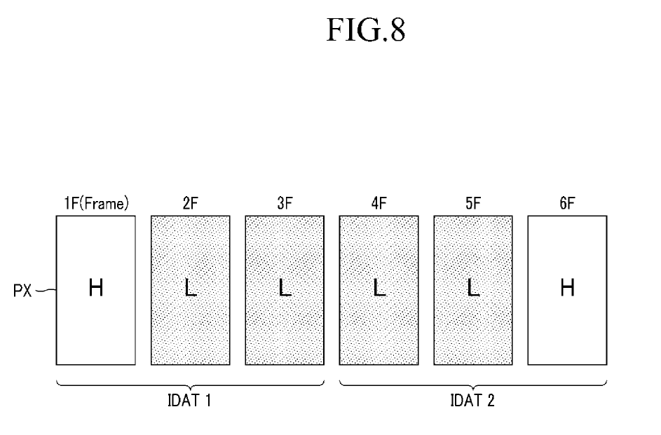

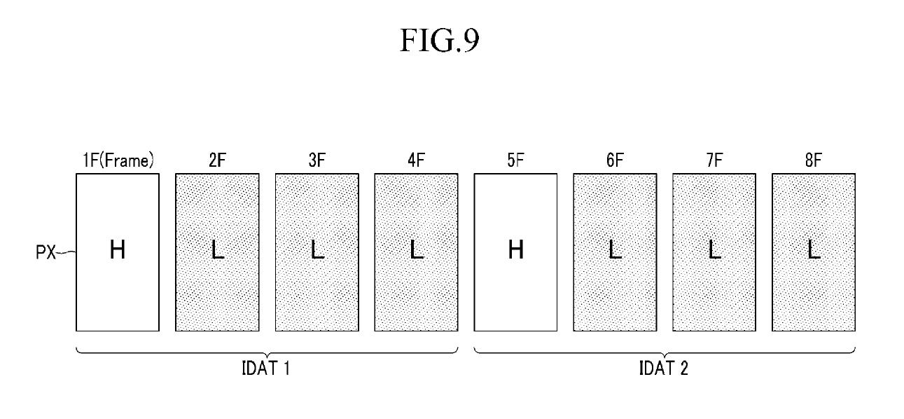

FIGS. 4-9 illustrate various exemplary images displayed by a pixel PX in association with a time division driving scheme. In FIGS. 4-6, a pixel PX may display an image with respect to an input image signal IDAT by setting two sequential frames as a frame set; whereas in FIGS. 7 and 8, a pixel PX may display an image with respect to an input image signal IDAT by setting three sequential frames as a frame set. In FIG. 9, a pixel PX may display an image for an input image signal IDAT by setting four sequential frames as one frame set. It is contemplated, however, that any suitable number of sequential frames may be set as a frame set.

First, referring to FIG. 4, when a pixel PX displays a first image H according to a first gamma curve GH in a first frame IF, which is a first frame in a frame set with respect to a first input image signal IDAT1, and displays a second image L according to a second gamma curve GL in a second frame 2F, which is a second frame in the frame set with respect to the first input image signal IDAT1, the pixel PX may display the second image L in a third frame 3F, which is a first frame in a next frame set with respect to a second input image signal IDAT2, and display the first image H in a fourth frame 4F, which is a second frame in the next frame set with respect to the second input image signal IDAT2. In this manner, the TGM mode may be referred to as an HL-LH mode.

Referring to FIG. 5, when a pixel PX displays the first image H in the first frame IF, which is the first frame in a frame set with respect to the first input image signal IDAT1 and displays the second image L in the second frame 2F, which is the second frame in the frame set with respect to the first input image signal IDAT1, the pixel PX may display the first image H in the third frame 3F, which is the first frame in the next frame set with respect to the second input image signal IDAT2, and display the second image L in the fourth frame 4F, which is the second frame in the next frame set with respect to the second input image signal IDAT2. In this manner, the TGM mode may be referred to as an HL-LH mode.

As an alternative to the exemplary TGM mode illustrated in FIG. 5, when the pixel PX displays the second image L in the first frame IF, which is the first frame in a frame set with respect to the first input image signal IDAT1, and displays the first image H in the second frame 2F, which is the second frame in the frame set with respect to the first input image signal IDAT1, the pixel PX may display the second image L in the third frame 3F, which is the first frame in the next frame set with respect to the second input image signal IDAT2, and display the first image H in the fourth frame 4F, which is the second frame in the next frame set with respect to the second input image signal IDAT2. In this manner, the TGM mode may be referred to as an LH-LH mode.

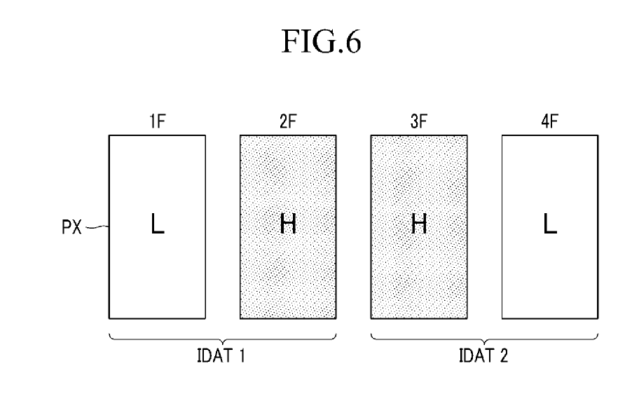

Referring to FIG. 6, when a pixel PX displays the second image L according to the second gamma curve GL in the first frame IF, which is the first frame in a frame set with respect to the first input image signal IDAT1, and displays the first image H according to the first gamma curve GH in the second frame 2F, which is the second frame in the frame set with respect to the first input image signal IDAT1, the pixel PX may display the first image H in the third frame 3F, which is the first frame in the next frame set with respect to the second input image signal IDAT2, and display the second image L in the fourth frame 4F, which is the second frame in the next frame set with respect to the second input image signal IDAT2. In this manner, the TGM mode may be referred to as an LH-HL mode.

Referring to FIGS. 7 and 8, a pixel PX may display an image with respect to an input image signal IDAT by setting three sequential frames as a frame set. For example, a pixel PX may display an image for the first input image signal IDAT1 in three sequential frames 1F, 2F, and 3F, and display an image for the second input image signal IDAT2 in three sequential frames 4F, 5F, and 6F. That is, as seen in FIG. 7, a pixel PX may display the first image H for the first and fourth frames 1F and 4F, which are the first frames among the three frames included in a frame set, and display the second image L for the remaining two frames 2F, 3F, 5F, and 6F, which are the second and third frames among the three frames included in the frame set. In this manner, the TGM mode may be referred to as an HLL-HLL mode.

Referring to FIG. 8, the TGM mode is almost the same as illustrated in FIG. 7; however, the order of the first image H and the second image L displayed by a pixel PX in two sequential frame sets may be reversed. In this manner, the TGM mode may be referred to as an HLL-LLH mode.

Referring to FIG. 9, a pixel PX may display an image for an input image signal IDAT by setting four sequential frames as one frame set. In this manner, the TGM mode may be referred to as an HLLL-HLLL mode.

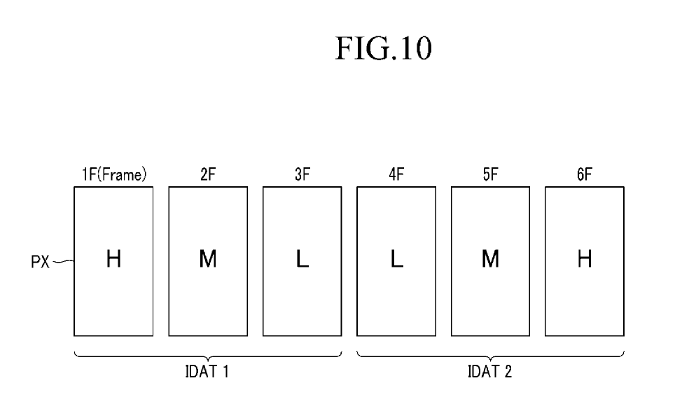

Adverting to FIG. 10, a pixel PX may display an image using three different gamma curves GH, GL, and GM as illustrated in FIG. 3. For example, a frame in which a third image M according to a third gamma curve GM may be positioned between two frames in which the first image H and the second image L are displayed with respect to one of the input image signals IDAT1 and IDAT2. Further, the order of displaying the images with respect to the adjacent input image signals IDAT1 and IDAT2 may be reversed. In this manner, FIG. 10 illustrates an exemplary HML-LMH mode.

As previously mentioned, any suitable number of frames may be set with respect to an input image signal IDAT. To this end, any suitable kind of displayed image may be variously changed according to a frame order.

According to exemplary embodiments, the liquid crystal display may include a plurality of dots Dot1, Dot2, Dot3, and Dot4 that is arranged in a matrix form. Each of the dots Dot1, Dot2, Dot3, and Dot4 may include a plurality of pixels PX1, PX2, and PX3 configured to display different colors, e.g., different primary colors, such as, for example, red, green, and blue colors, respectively.

FIG. 11 illustrates an example in which each of the pixels PX1, PX2, and PX3 displays an image in an HL-LH mode or an LH-HL mode. That is, adjacent pixels PX1, PX2, and PX3 in a row direction or column direction may display images according to different TGM modes. As a result, a flicker phenomenon may be reduced. Further, according to exemplary embodiments, polarities of data voltages of adjacent pixels PX1, PX2, and PX3 may be opposite to each other, and a polarity of a data voltage of each of the pixels PX1, PX2, and PX3 may be frame-inversed. In addition, a method to display an image according to time division driving in adjacent pixels PX1, PX2, and PX3 may be variously changed.

Adverting back to FIG. 1, the image signal processor 620 includes an image signal correction unit 622 and a dithering unit 624.

The image signal correction unit 622 is configured to correct the doubled and TGM-signal processed input image signal IDAT in accordance with the liquid crystal display to generate a corrected image signal. Exemplary correction techniques include accurate color capture (ACC) processing, dynamic capacitance compensation (DCC) processing, and the like. The number of bits in the corrected image signal generated by the correction technique may be different from the number of bits in the input image signal IDAT before correction. Correction data stored in a separate memory or a lookup table may be used during correction.

The dithering unit 624 temporally dither-processes the corrected image signal to express the gray scale of the corrected image signal, and, thereby, to transmit the dithered image signal to the data driver 500 as an output image signal DAT. The temporal dither-processing is a method of expressing the gray scale of the corrected image signal as an average gray scale for a plurality of adjacent frames with respect to a pixel.

An exemplary image signal processor 620 is described in more detail in association with FIGS. 12-14.

Referring to FIG. 12, the image signal correction unit 622 of the image signal processor 620 may be configured to perform ACC processing. In exemplary embodiments, red R, green G, and blue B are exemplified as the primary colors. In this manner, the image signal correction unit 622 may include an R data correction unit 622a, a G data correction unit 622b, and a B data correction unit 622c. To this end, the dithering unit 624 may include corresponding R, G, and B dithering units 624a, 624b, and 624c that are connected to the R, G, and B data correction units 622a, 622b, and 622c, respectively.

The R, G, and B data correction units 622a, 622b, and 622c convert “n” (“n” is a natural number) bits of input image signals R, G, and B of respective R, G, and B signals input from the TGM unit 610 into “m” (“m” is a natural number) bits of image data R′, G′, and B′, which are determined in accordance with a characteristic of the liquid crystal display. The “m” bits of image data R′, G′, and B′ are then output as the converted image data to the R, G, and B dithering units 624a, 624b, and 624c as the corrected image signals, respectively. The “n” bits and the “m” bits may be the same as each other or may be different from each other, but generally, “m” is typically larger than “n.” To this end, the R, G, and B data correction units 622a, 622b, and 622c may store a lookup table (hereinafter, referred to as an LUT) to facilitate converting “n” bits of input image signals R, G and B into “m” bits of image data R′, G′, and B′.

For example, the R, G and B data correction units 622a, 622b, and 622c for the ACC processing may correct gamma aspects of the input image signals. The ACC processing of the R, G and B data correction units 622a, 622b, and 622c will be described in more detail with reference to FIG. 13.

Referring to FIG. 13, for example, in order to reduce luminance of a blue input image signal B corresponding to a 130 gray scale in accordance with a target gamma curve, B image data of a gray scale corresponding to the luminance may be input. That is, in the example of FIG. 13, when the B input image signal corresponding to a 128.5 gray scale is input, a desired luminance value may be acquired. Accordingly, the B input image signal of the 130 gray scale may be corrected to the 128.5 gray scale of the B image data based on the LUT stored in (or associated with) the B data correction unit 622c. When, however, the input image signal is 8 bits, the 128.5 gray scale may not be expressed, and, as a result, the 128.5 gray scale may be expressed using a larger number of bits. For example, when 10 bits are used, the 128.5 gray scale may correspond to 514 (=128.5×4).

Accordingly, “m” bits (where “m”>“n”) of image data R′, G′, and B′ corresponding to each of 2ⁿ input image signals (of “n” bits) of each of R, G, and B input to the signal controller 600 may be stored and used in the LUT of the R, G, and B data correction units 622a, 622b, and 622c. When bits of the data that can be processed in the data driver 500 are not “m” bits, in the R, G, and B dithering units 624a, 624b, and 624c, “m” bits of image data R′, G′, and B′ may be dither-processed to be provided to the data driver 500 in the R, G, and B dithering units 624a, 624b, and 624c.

The R, G, and B dithering units 624a, 624b, and 624c perform the dither-processing while converting the “m” bits of image data R′, G′, and B′ into “n” bits of image data R″, G″, and B″ of the respective R, G, and B to output the dither-processed image data as the output image signal DAT. While illustrated as three separate units, the R, G, and B dithering units 624a, 624b, and 624c may be provided as one or any suitable number of dithering units.

According to exemplary embodiments, dither-processing may be performed according to various stored dithering patterns in a memory associated with the liquid crystal display. Dither-processing may represent target luminance through temporal dither-processing, for example, to acquire an average of the displayed images of a plurality of frames with respect to a pixel PX. When the liquid crystal display is driven by only a temporal dither-processing technique, since flickering in a display screen may occur, a spatial dithering mode may also be used. A spatial dithering mode is a control mode to display different luminance according to a position of the pixel PX even though the adjacent pixels PX display the same gray level.

For example, referring to FIG. 14, a dithering pattern is shown where a difference between “m” bits and “n” bits is 2 bits. The “m” bits of image data R′, G′, and B′ are divided into upper bits of data N and lower 2 bits of data, and the lower 2 bits of data become “00”, “01”, “10”, or “11”.

To display the lower 2 bits of data as “00”, four adjacent pixels PX may be expressed as the upper bits of data N, and each pixel PX may express all the upper bits of data N for four adjacent frames T, T+1, T+2, and T+3.

To display the lower 2 bits of data as “01”, one of four adjacent pixels PX may express a value acquired by adding 1 to the upper bits of data N, and the rest of the pixels may express the upper bits of data N. Further, each pixel PX may temporally express a value acquired by adding 1 to the upper bits of data N for a frame of the four adjacent frames T, T+1, T+2, and T+3, but expresses the upper bits of data N for the rest of the frames. Average luminance of the four pixels and average luminance of a pixel for four frames T, T+1, T+2, and T+3 becomes N+0.25.

To display the lower 2 bits of data as “10”, two pixels of the four adjacent pixels PX may express a value acquired by adding 1 to the upper bits of data N, and the rest of the pixels may express the upper bits of data N. Each pixel PX may express a value acquired by adding 1 to the upper bits of data N for two frames of the four adjacent frames T, T+1, T+2, and T+3, but expresses the upper bits of data N for the rest of the frames. Average luminance of the four pixels and average luminance of a pixel for four frames T, T+1, T+2, and T+3 becomes N+0.5.

To display the lower 2 bits of data as “11”, three pixels of the four adjacent pixels PX may express a value acquired by adding 1 to the upper bits of data N, and the remaining pixel may express the upper bits of data N. Each pixel PX may express a value acquired by adding 1 to the upper bits of data N for three frames of the four adjacent frames T, T+1, T+2, and T+3, but expresses the upper bits of data N for the rest of the frames. Average luminance of the four pixels and average luminance of a pixel for four frames T, T+1, T+2, and T+3 becomes N+0.75.

According to exemplary embodiments, when a difference between “m” bits and “n” bits is “k” bits (where “k” is a natural number of 1 or more), the number of frames of a dithering pattern set to temporally dithering with respect to a gray scale may be 2^{k} sequential frames. Further, the lower bits of the “m” bits of the image data R′, G′, and B′ may be “k” bits. For example, when the lower bits are 3 bits, the lower 3 bits of data become “000”, “001”, “010”, “011”, “100”, “101”, “110”, and “111”.

An exemplary display driving method to drive the liquid crystal display of FIG. 1 will now be described in more detail.

According to exemplary embodiments, the signal controller 600 receives an input image signal IDAT and an input control signal ICON to control a display of the input image signal IDAT from a graphic controller. The input image signal IDAT relays luminance information of each pixel PX, and luminance may relate to a determined number of gray scales. The TGM unit 610 of the signal controller 600 doubles and TGM signal-processes the input image signal IDAT and transmits the doubled and TGM-signal processed signal to the image signal processor 620. The image signal processor 620 corrects and dither-processes the doubled and TGM-signal processed input image signal IDAT in accordance with the liquid crystal display to convert the corrected and dither-processed input image signal IDAT into the output image signal DAT.

The signal controller 600 generates a gate control signal CONT1, a data control signal CONT2, a gamma control signal CONT3, and the like, based on the input control signal ICON. The signal controller 600 transmits the gate control signal CONT1 to the gate driver 400, the data control signal CONT2 and the output image signal DAT to the data driver 500, and the gamma control signal CONT3 to the gray voltage generator 800. The data control signal CONT2 may further include an inversion signal to invert a polarity of the data voltage Vd (referred to as a “polarity of the data voltage”) with respect to the common voltage Vcom. The gamma control signal CONT3 may include gamma data for one or more gamma curves.

The gray voltage generator 800 generates gray voltages or a determined number of reference gray voltages according to the gamma control signal CONT3 and transmits the generated gray voltages or reference gray voltages to the data driver 500. The gray voltages may be provided according to different gamma curves, respectively, and the gray voltage for the gamma curve selected through a separate selection process may be generated.

The data driver 500 receives the output image signal DAT for pixels PX in a row according to the data control signal CONT2 from the signal controller 600 and selects a gray voltage corresponding to each output image signal DAT to convert the output image signal DAT into an analog data voltage Vd. The data driver 500 applies the converted output image signal to the corresponding data lines D1-Dm.

The gate driver 400 applies a gate-on voltage Von to the gate lines G1-Gn according to the gate control signal CONT1 from the signal controller 600 to turn on corresponding switching elements connected to the gate lines G1-Gn relating to the pixels PX of a row. The data voltages Vd applied to the data lines D1-Dm may be applied to the corresponding pixels PX through the turned-on switching elements. When the data voltage Vd is applied to a pixel PX, a generated electric field in the liquid crystal layer associated with the pixel PX controls the degree of tilt of liquid crystal molecules in the associated region of the liquid crystal layer disposed between the upper and lower display panels to control polarization of light, and, in this manner, the pixel PX may display luminance corresponding to the gray scale of the input image signal IDAT.

The process may be repeated by setting a horizontal period (referred to as “1H”, and being the same as a period of a horizontal synchronizing signal Hsync and a data enable signal DE), and, as such, the gate-on voltages Von may be sequentially applied to all the gate lines G1-Gn and the data voltages Vd may be applied to all the pixels PX to display an image for a frame.

When the frame ends, the next frame starts, and a state of the inversion signal included in the data control signal CONT2 may be controlled so that the polarity of the data voltage Vd applied to each pixel PX is opposite to the polarity in the previous frame (referred to as “frame inversion”). The polarities of the data voltages Vd applied to all the pixels PX may be inverted for every one or more frames during the frame inversion. Even in one frame, a polarity of the data voltage Vd flowing through at least one of the data lines D1-Dm may be periodically changed according to the inversion signal, or the polarities of the data voltages Vd applied to the data lines D1-Dm in a pixel row may be different from each other.

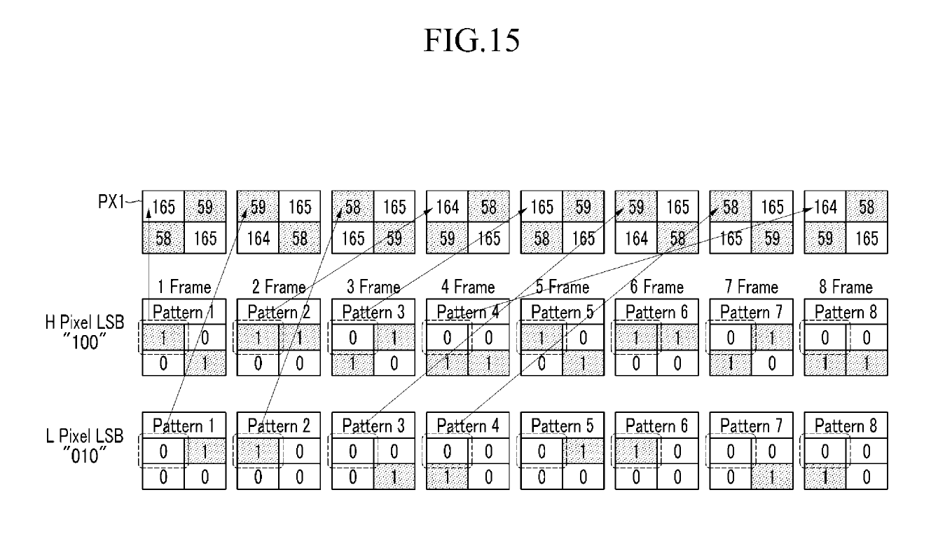

With continued reference to FIGS. 1-14, the exemplary liquid crystal display of FIG. 1 will be described in more detail in association with FIGS. 15-17.

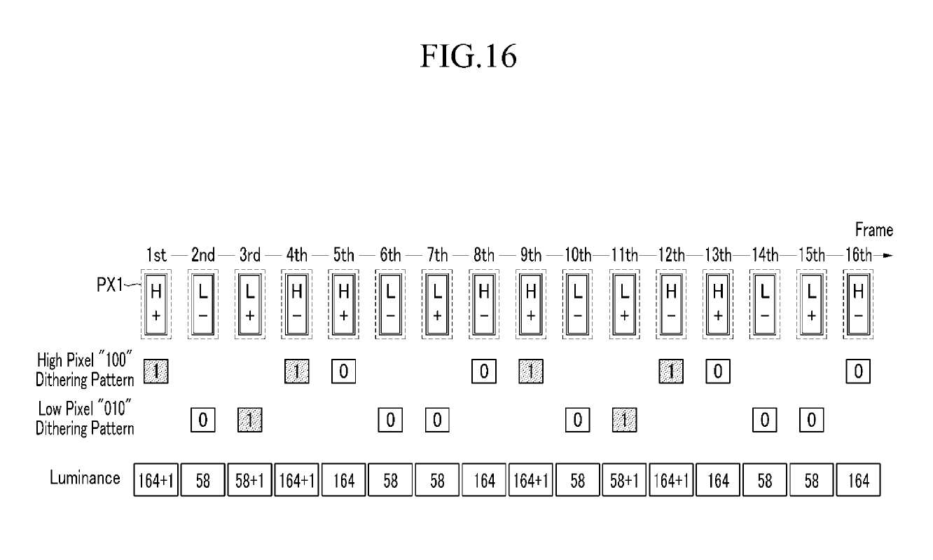

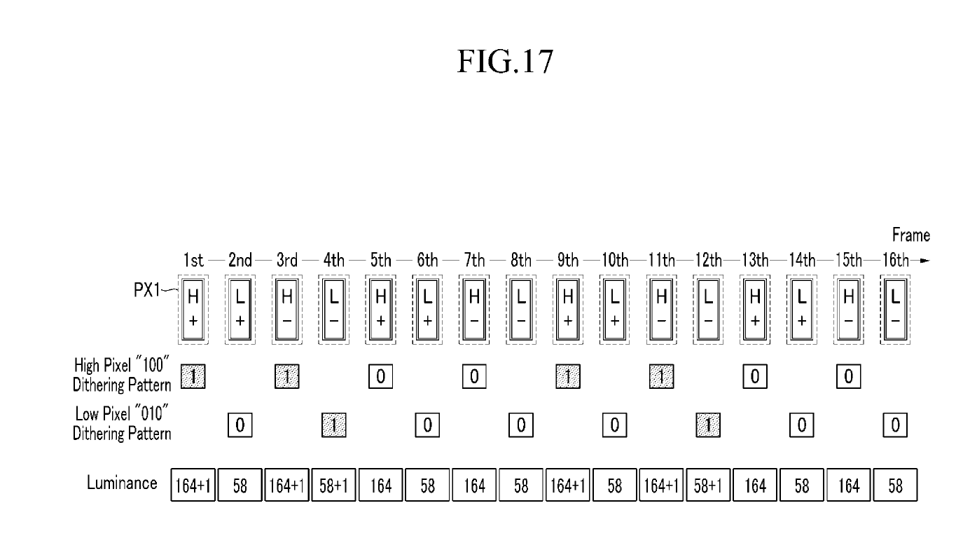

FIG. 15 is a diagram of an image signal processing method for a pixel in the liquid crystal display of FIG. 1, according to exemplary embodiments. FIG. 16 is a timing diagram of an image signal processing method for a pixel in the liquid crystal display of FIG. 1 when a temporal gamma mixing (TGM) mode is an HL-LH or LH-HL mode. FIG. 17 is a timing diagram of an image signal processing method for a pixel in the liquid crystal display of FIG. 1 when a TGM mode is an HL-HL or LH-LH mode.

According to exemplary embodiments, when a difference between the bit number of the “m” bits of the image data R′, G′, and B′ and the bit number of the “n” bits of image data R″, G″, and B″ is “k” bits, and the number of kinds of gamma curves applied in the TGM signal-processing for an input image signal IDAT is “j” (“j” is a natural number of 2 or more), the dithering unit 624 receiving the corrected image signal from the image signal correction unit 622 temporally dither-processes the input image signal IDAT using a dithering pattern set through 2^{k} frames with respect to each gamma curve. In this manner, to display target luminance of the corrected image signal, 2^{k}×“j” sequential frames are utilized. That is, to express target luminance by signal correction for each image according to each gamma curve, all the dithering patterns in one set for the corresponding gamma curve are sequentially applied to all the frames in which the images according to the corresponding gamma curve are displayed.

For example, referring to FIG. 15, when a difference between the bit number of the “m” bits of the image data R′, G′, and B′ and the bit number of the “n” bits of the image data R″, G″, and B″ input to the data driver 500 is 3 bits, the first gamma curve GH and the second gamma curve GL may be applied, in which the number of kinds of gamma curves applied in the TGM signal-processing for an input image signal IDAT is 2. In this manner, the TGM mode may be set as the HL-LH mode or LH-HL mode, and the gray scale of the input image signal for the first image H may be a 165 gray scale, and the gray scale of the input image signal for the second image L may be a 58 gray scale. Further, the lower bits of the image data for the first image H corrected in the image signal correction unit 622 and the lower bits of the image data for the second image L may be “100” and “010”, respectively. In this manner, target luminance of the image data for the first image H corrected in the image signal correction unit 622 may be 164.5, and the target luminance of the image data for the second image L may be 58.25.

For convenience of illustration, FIG. 15 illustrates about half of the entire frame utilized to express the target luminance. For example, when the pixels PX of the liquid crystal display are to display the images as illustrated in FIG. 11, since a TGM mode applied to a pixel PX1 (e.g., an upper left pixel among four adjacent pixels in FIG. 16) is the HL-LH or LH-HL mode, the images may be displayed in the order of H(164)-L(58)-L(58)-H(164)-H(164)-L(58)-L(58)-H(164), etc. The dithering patterns applied to the first image H 164 by correction in the image signal correction unit 622 are eight first dithering pattern sets corresponding to the lower bits “100”, and the dithering patterns applied to the second image L 58 are eight second dithering pattern sets corresponding to the lower bits “010”. It is noted, however, that the dithering pattern sets illustrated in FIG. 15 are merely illustrative, and, therefore, any suitable number and/or pattern may be utilized. In any event, the first dithering pattern sets may be sequentially applied to the frames in which the corresponding pixel PX1 displays the first image H, and the second dithering pattern sets may be sequentially applied to the frames in which the corresponding pixel PX1 displays the second image L.

According to exemplary embodiments, as illustrated by an arrow in FIG. 15, the corresponding pixel PX1 expresses a 165 gray scale when the first pattern of the first dithering pattern set is applied in the first frame, expresses a 59 gray scale when the first pattern of the second dithering pattern set is applied in the second frame, expresses a 58 gray scale when the second pattern of the second dithering pattern set is applied in the third frame, expresses a 164 gray scale when the second pattern of the first dithering pattern set is applied in the fourth frame, expresses a 165 gray scale when the third pattern of the first dithering pattern set is applied in the fifth frame, expresses a 59 gray scale when the third pattern of the second dithering pattern set is applied in the sixth frame, expresses a 58 gray scale when the fourth pattern of the second dithering pattern set is applied in the seventh frame, and expresses a 164 gray scale when the fourth pattern of the first dithering pattern set is applied in the eighth frame. Although not illustrated, the corresponding pixel PX1 may then be processed by the same method.

FIG. 16 illustrates a value of the dithering pattern and target luminance applied to the corresponding pixel PX1 for a total of 16 frames to display the target luminance under the same condition as described in association with FIG. 15.

FIG. 17 illustrates a value of the dithering pattern and target luminance applied to the corresponding pixel PX1 for 16 frames to display the target luminance of the corresponding pixel PX1 when the TGM mode is the HL-HL or LH-LH mode. Since presentation and processing methods are substantially similar as those described in association with FIGS. 15 and 16, a duplicative description has been omitted to avoid obscuring exemplary embodiments described herein.

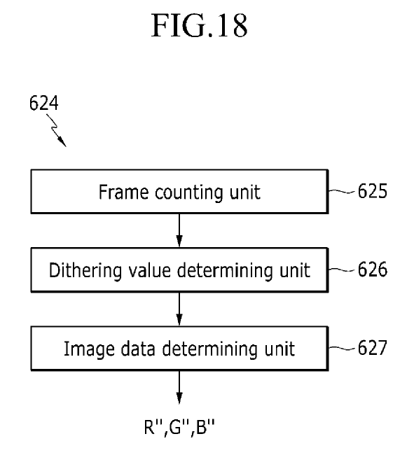

According to exemplary embodiments, the number of frames for each image according to each gamma curve may be counted so that the corresponding dithering pattern sets are sequentially applied for each image according to each gamma curve. To this end, an exemplary dithering unit 624 will be described in more detail in association with FIG. 18, together with the drawings described above.

FIG. 18 is a block diagram of a dithering unit, according to exemplary embodiments.

Referring to FIG. 18, the dithering unit 624 of the signal controller 600 may include a frame counting unit 625, a dithering value determining unit 626, and an image data determining unit 627. The dithering unit 624 illustrated in FIG. 18 may correspond to each of the R, G, and B dithering units 624a, 624b, and 624c illustrated in FIG. 12 or may be the R, G, and B dithering units 624a, 624b, and 624c combined as one dithering unit.

The frame counting unit 625 is configured to count frames for each image data to which each gamma curve is applied, in order to select a dithering pattern to be applied for dither-processing the image data R′, G′, and B′, which are corrected and output by the image signal correction unit 622 after being doubled and TGM signal-processed by the TGM unit 610. That is, according to exemplary embodiments, the gamma curve of the image according to a frame displayed by a pixel PX may vary according to time division driving according to the plurality of gamma curves. Further, when the applied gamma curves are different according to an order of the frames, since the expressed gray scales for the same input image signal IDAT may be different from each other, the dithering patterns applied during the dither-processing may also vary. Accordingly, a dithering pattern applied to each frame is determined and a dithering value is determined according to the determined TGM mode. In this manner, as described above, the dithering patterns of one set to be applied to each gamma curve may be sequentially applied to a frame in which an image is displayed for each corresponding gamma curve. Accordingly, the frame in which the image is displayed for each gamma curve may be counted.

For example, when performing time division driving using two kinds of gamma curves, such as the first and second gamma curves GH and GL, the frame counting unit 625 determines whether the input image data R′, G′, and B′ are the first image H according to the first gamma curves GH or the second image L according to the second gamma curve GL. When the corresponding image data R′, G′, and B′ are the first image H, the frame count for the first image H is increased by 1, and when the corresponding image data R′, G′, and B′ are the second image L, the frame count for the second image L is increased by 1. Frame counting is performed for each image according to each gamma curve.

The dithering value determining unit 626 is configured to determine a dithering pattern to be applied to an image to be displayed in each frame according to the frame counting result determined by the frame counting unit 625. The dithering value determining unit 626 is also configured to determine a dithering value to be applied to each pixel PX.

For example, when performing time division driving using two kinds of gamma curves, such as the first and second gamma curves GH and GL, a dithering pattern set corresponding to the lower bits of the image data R′, G′, and B′ for the first image H may be referred to as a first dithering pattern set, and a dithering pattern set corresponding to the lower bits of the image data R′, G′, and B′ for the second image L may be referred to as a second dithering pattern set. In this manner, when the frame counting for the first image H is increased in the frame counting unit 625, the dithering value is determined from a dithering pattern of the next fame of the dithering pattern applied in the previous frame among the dithering patterns of the first dithering pattern set. Similarly, when the frame counting for the second image L is increased in the frame counting unit 625, the dithering value is determined from a dithering pattern of the next fame of the dithering pattern applied in the previous frame among the dithering patterns of the second dithering pattern set. The detailed operation of the dithering value determining unit 626 may be understood with reference to FIGS. 15-17 and their corresponding detailed descriptions provided in the preceding paragraphs.

The image data determining unit 627 is configured to determine the image data R″, G″, and B″ for each frame. That is, the output image signal DAT is determined by performing a temporal dither-processing using a dithering value for each pixel PX determined in the dithering value determining unit 626.

According to exemplary embodiments, the gate driver 400, the data driver 500, the signal controller 600, and/or the gray voltage generator 800 may be implemented via one or more general purpose and/or special purpose components, such as one or more discrete circuits, digital signal processing chips, integrated circuits, application specific integrated circuits, microprocessors, processors, programmable arrays, field programmable arrays, instruction set processors, and/or the like.

According to exemplary embodiments, the processes described herein to facilitate image signal processing may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. In this manner, the display device of FIG. 1 may include or otherwise be associated with one or more memories including code (e.g., instructions) configured to cause the display device to perform one or more of the processes described herein.

The memories may be any medium that participates in providing code/instructions to the one or more software, hardware, and/or firmware for execution. Such memories may take many forms, including but not limited to non-volatile media, volatile media, and transmission media. Non-volatile media include, for example, optical or magnetic disks. Volatile media include dynamic memory. Transmission media include coaxial cables, copper wire and fiber optics. Transmission media can also take the form of acoustic, optical, or electromagnetic waves. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method to process an image signal, comprising:
receiving an input image signal;
doubling the input image signal into frames;
determining a temporal gamma mixing (TGM) mode to control an order in which different gamma curves are to be applied to the doubled input image signal, the different gamma curves comprising a first gamma curve and a second gamma curve;
applying the different gamma curves to the doubled input image signal based on the TGM mode to generate a doubled, TGM-processed image signal;
correcting the doubled, TGM-processed image signal to generate a corrected image signal; and
dither-processing the corrected image signal to generate an output image signal,
wherein dither-processing the corrected image signal comprises:
performing dither-processing by sequentially applying dithering patterns of a first dithering pattern set to the corrected image signal in association with first ones of the frames with respect to the first gamma curve, and
performing dither-processing by sequentially applying dithering patterns of a second dithering pattern set to the corrected image signal in association with second ones of the frames with respect to the second gamma curve, and
wherein the first dithering pattern set is different from the second dithering pattern set.

2. The method of claim 1, further comprising:
determining which gamma curve among the gamma curves is to be applied to a current frame of the corrected image signal; and
increasing a frame count for the determined gamma curve by 1.

3. The method of claim 2, wherein dither-processing of the corrected image signal further comprises:
determining a dithering pattern to be applied to each frame based on the frame count of the determined gamma curve; and
determining a dithering value to be applied to a pixel using the determined dithering pattern.

4. The method of claim 3, wherein, when a difference between a bit number of the output image signal and a bit number of the corrected image signal is “k” bits, “k” being a natural number of 1 or more, and a number of the gamma curves is “j,” “j” being a natural number of 2 or more, the method further comprises:
displaying target luminance of the output image signal in 2^{k}×j sequential frames.

5. The method of 4, wherein correcting the doubled, TGM-processed image signal comprises:
applying accurate color capture (ACC) processing to the doubled input image signal.

6. The method of claim 5, further comprising:
converting the output image signal into one or more data voltages.

7. The method of claim 1, wherein, when a difference between a bit number of the output image signal and a bit number of the corrected image signal is “k” bits, k being a natural number of 1 or more, and a number of the gamma curves is “j.” “j” being a natural number of 2 or more, the method further comprises:
displaying target luminance of the output image signal in 2^{k}×j sequential frames.

8. The processing method of an image signal of claim 1, wherein correcting the doubled input image signal comprises:
applying accurate color capture (ACC) processing to the doubled input image signal.

9. The method of claim 1, further comprising:
converting the output image signal into one or more data voltages.

10. A display device, comprising:
a temporal gamma mixing (TGM) unit configured to:
double an input image signal into frames, and
apply different gamma curves to the doubled input image signal to generate a doubled, TGM-processed image signal, the different gamma curves comprising a first gamma curve and a second gamma curve;
an image signal correction unit configured to correct the doubled, TGM-processed image signal to generate a corrected image signal; and
a dithering unit configured to dither-process the corrected image signal to generate an output image signal,
wherein the dithering unit is configured to perform the dither-processing by:
sequentially applying dithering patterns of a first dithering pattern set to the corrected image signal in association with first ones of the frames with respect to the first gamma curve, and
sequentially applying dithering patterns of a second dithering pattern set to the corrected image signal in association with second ones of the frames with respect to the second gamma curve,
wherein the first dithering pattern set is different from the second dithering pattern set.

11. The display device of claim 10, wherein the dithering unit comprises:
a frame counting unit configured to:
determine which gamma curve among the gamma curves is to be applied to a current frame of the corrected image signal, and
increase a frame count for the determined gamma curve by 1.

12. The display device of claim 11, wherein the dithering unit further comprises:
a dithering value determining unit configured to:
determine a dithering pattern to be applied to each frame based on the frame count of the determined gamma curve, and
determine a dithering value to be applied to a pixel using the determined dithering pattern.

13. The display device of claim 12, wherein the dithering unit further comprises:
an image data determining unit configured to determine the output image signal using the dithering value determined by the dithering value determining unit.

14. The display device of claim 13, wherein, when a difference between a bit number of the output image signal and a bit number of the corrected image signal is “k” bits, “k” being a natural number of 1 or more, and a number of the gamma curves is “j,” “j” being a natural number of 2 or more, the display device is configured to:
display target luminance of the output image signal in 2^{k}×j sequential frames.

15. The display device of claim 14, wherein:
the image signal correction unit is configured to apply accurate color capture (ACC)-processing to the doubled input image signal.

16. The display device of claim 15, wherein:
the image signal correction unit comprises respective data correction units for each of a plurality of colors.

17. The display device of claim 16, further comprising:
a data driver configured to convert the output image signal into one or more data voltages.

18. The display device of claim 10, wherein, when a difference between a bit number of the output image signal and a bit number of the corrected image signal is “k” bits, “k” being a natural number of 1 or more, and a number of the gamma curves is “j,” “j” being a natural number of 2 or more, the display device is configured to:
display target luminance of the output image signal in 2^{k}×j sequential frames.

19. The display device of claim 10, wherein:
the image signal correction unit is configured to apply accurate color capture (ACC)-processing to the doubled input image signal.

20. The display device of claim 10, further comprising:
a data driver configured to convert the output image signal into one or more data voltages.
